(19) United States
(12) Patent Application Publication
(10) Pub. No.: US 2025/0129500 A1
(43) Pub. Date: Apr. 24, 2025

(54) Production of 177Lu from Yb Targets

(71) Applicant: The Curators of The University of Missouri, Columbia, MO (US)

(72) Inventors: John David Robertson, Columbia, MO (US); John D Lydon, Columbia, MO (US); Alexander Garnov, Columbia, MO (US)

(21) Appl. No.: 18/721,338

(22) PCT Filed: Dec. 16, 2022
(86) PCT No.: PCT/US2022/053176

§ 371 Date: Jun. 18, 2024

Related U.S. Application Data
(60) Provisional application No. 63/292,286, filed on Dec. 21, 2021.

(51) Int. Cl. C25C 1/22; C25C 7/02; C25C 7/06; G21G 1/00

(52) U.S. Cl. CPC C25C 1/22; C25C 7/02; C25C 7/06; G21G 1/001; G21G 2001/0094

(57) ABSTRACT

The present disclosure relates to methods for separating lanthanides and methods for producing non carrier added (n.c.a) ¹⁷⁷Lu, for use in particular in nuclear medicine, for diagnostic and/or therapeutic purposes.

### CROSS REFERENCE TO RELATED APPLICATIONS

This International patent application claims the benefit of U.S. Provisional Patent Application No. 63/292,286, which was filed on Dec. 21, 2021, and is incorporated herein by reference in its entirety.

### TECHNICAL FIELD

The present disclosure relates to methods for separating lanthanides and in particular methods for producing non carrier added (n.c.a) ¹⁷⁷Lu, for use in particular in nuclear medicine, for diagnostic and/or therapeutic purposes.

### BACKGROUND

Lutetium-177 (¹⁷⁷Lu) is accessible via (n,γ) reaction. There are two methods of ¹⁷⁷Lu production in a nuclear reactor. One method comprises irradiation of ¹⁷⁶Lu, leading to the direct formation of ¹⁷⁷Lu. However, this method leads to concomitant formation of the metastable ^{177m}Lu isomer. The presence of this long-lived isomer (half-life of 160 days) reduces the radionuclidic purity of ¹⁷⁷Lu significantly. The long-lived isomer also leads to serious problems concerning waste disposal.

The second method involves beta decay of the short-lived radioisotope Ytterbium-177 (¹⁷⁷Yb) (half-life of 1.9 hours), which is produced by neutron capture of an enriched ¹⁷⁶Yb (>99%) target. The low thermal neutron cross section of the ¹⁷⁶Yb (n,γ) to ¹⁷⁷Yb reaction (2.85 barn), however, results in a production of only very small amounts of the desired ¹⁷⁷Lu in comparison with the total mass of the target. Since radioisotopes with high specific activity and high radionuclidic purity are required in nuclear medicine, minute quantities of ¹⁷⁷Lu must be separated from substantial amounts of ¹⁷⁶Yb, so that non-carrier-added (n.c.a)¹⁷⁷Lu with a maximum specific activity is obtained (U.S. Pat. No. 6,716,353 B1).

Separation of the two lanthanides is challenging due to their similar chemical properties. Known separation methods include chromatographic methods such as ion-exchange chromatography and extraction chromatography (U.S. Pat. No. 6,716,353 B1; G. Choppin, R. Silva, Journal of Inorganic and Nuclear Chemistry, 1956, vol. 3, no. 2, pp. 153-154). Due to the high mass ratio of Yb:Lu in the processed target after neutron capture, separation of ¹⁷⁷Lu necessitates excessive amounts of expensive chromatographic resin and involves multistep processes, so that overall process time is undesirably long, in particular with regard to commercial production (E. Horwitz, D. McAlister, A. Bond, R. Barans, J. Williamsons, A process for the separation of 177Lu from neutron irradiated 176Yb targets, Applied Radiation and Isotopes, 2005, vol. 63, no. 1, pp. 23-36; L. Van So, N. Morcos, M. Zaw, P. Pellegrini, I. Greguric et al., Alternative chromatographic processes for no-carrier added 177Lu radioisotope separation. Part I. Multi-column chromatographic process for clinically applicable, Journal of Radioanalytical and Nuclear Chemistry, 2008, vol. 277, no. 3, pp. 663-673, 675-683). Moreover, chromatographic methods achieve acceptable degrees of separation only at a Yb:Lu mass ratio up to 1000:1 (R. Mikolajczak, “Separation of microgram quantities of Lu-177 from milligram amounts of Yb by the extraction chromatography”, 5^{th} International Conference on Isotopes, Brussels, 2005). However, the mass ratio Yb:Lu of the processed target is usually significantly higher by an order of magnitude or more.

An alternative method is the selective extraction of ytterbium from the mixture of ¹⁷⁷Lu/Yb by way of electrolytic reduction of Yb³⁺ to Yb²⁺ and adsorption in a mercury electrode (amalgamation) (A. Bilewicz, K. Zuchowska, B. Bartos, Separation of Yb as YbSO4 from the 176Yb target for production of 177Lu via the 176Yb(n, γ)177Yb→177Lu process, Journal of Radioanalytical and Nuclear Chemistry, 2009, vol. 280, no. 1, pp. 167-169; N. A. Lebedev, A. F. Novgorodov, R. Misiak, J. Brockmann, F. Rösch, Radiochemical separation of no-carrier-added 177Lu as produced via the 176Yb(n,γ)177Yb→177Lu process, Applied Radiation and Isotopes, 2000, vol. 53, no. 3, pp. 421-425). Recently, R. Chakravarty et al. reported a process comprising two electrolytic steps which allegedly lead to an ytterbium separation yield of 99% in the absence of chromatographic purification steps (R. Chakravarty, T. Das. A. Dash, M. Venkatesh, Radiochemical separation of no-carrier-added 177Lu as produced via the 176Yb177Yb 177Lu process, Nuclear Medicine and Biology, 2010, vol. 37, no. 7, pp. 811-820). However, attempts to confirm the published separation yield-led to a separation yield of only 82% after a two-step electrolysis process also involving amalgamation (I. Cieszykowska, M. Zoltowska, M. Mielcarski, Separation of ytterbium from 177Lu/Yb mixture by electrolytic reduction and amalgamation, SOP Transactions on Applied Chemistry 2014, vol. 1, no. 2, pp. 6-13). While these authors achieved a separation yield of 94% by way of a three-step electrolysis, they state that the process is not sufficient for obtaining n.c.a ¹⁷⁷Lu of a very high level of purity.

Thus, there is still need for a time-efficient method that achieves a very high separation of 177Lu from 176 Yb as well as other impurities. There is also a need for a process which allows for processing several grams of processed target after neutron capture for commercial production of 177Lu. There is also a need for a method for preparing n.c.a 177Lu in a high specific activity.

### SUMMARY

The present disclosure relates to a method of separating a product lanthanide and a non-product lanthanide that are in a mixture, the method comprising separating the product lanthanide and the non-product lanthanide by electrolyzing the mixture and controlling the pH of the mixture to be about 6.0 to about 7.0 by addition of a base during electrolysis of the mixture. The base may be an alkali metal hydroxide and be selected from the group consisting of lithium hydroxide, sodium hydroxide and potassium hydroxide, preferably lithium hydroxide. By addition of a base, the pH may be preferably controlled to be about 6.5. The controlling of the pH may be periodic or continuous. Results to date suggest that controlling the pH at 6.5 using a base significantly improves the reduction of ytterbium (e.g., up to 99%) compared to using a lower pH. Moreover, the inventors could not repeat published results showing high yields of ytterbium reduction by the addition of hydrochloric acid during electrolysis.

The present disclosure also relates to a method of separating a product lanthanide and a non-product lanthanide comprising a step of pre-electrolysis, wherein an initial electrolyte solution comprising an alkali metal salt is conditioned by electrolysis so that at least a portion of the alkali metal ions of the alkali metal salt of the initial electrolyte solution are reduced to form a mercury amalgam.

The alkali metal salt may be selected from alkali metal tartrate, alkali metal acetate, alkali metal citrate and combinations thereof. The alkali metal may be lithium, sodium or potassium. In one embodiment, lithium citrate is used. By the step of conditioning the electrochemical cell the oxidation state of at least a portion of the lithium ions is reduced and the reduced lithium is amalgamated with the mercury cathode. Without being bound to a particular theory, results to date suggest that the conditioning of the initial electrolyte solution contributes substantially to scale and effectiveness of the electrochemical separation disclosed herein.

The present disclosure also relates to a method of separating a product lanthanide and a non-product lanthanide that are in a mixture by electrolysis, the method comprising conducting the electrolytic separation using a mercury cathode having a surface area that is “refreshed” during the electrolysis. More specifically, the surface area of the mercury cathode is refreshed during electrolysis by agitating or flowing or circulating the mercury so that mercury at or near the interface with the separation electrolyte solution comprising the lanthanide mixture is transported away from the interface after a relatively short period of time. This flow is intended to limit or even prevent the formation of a layer of reaction product(s) extending from the interface into the volume of the mercury cathode, wherein said layer would tend to inhibit the further reaction between the mercury and the lanthanide mixture (e.g., the reduction of the oxidation state of the non-product lanthanide and/or the amalgamation of the reduced non-product lanthanide). The aforementioned flow of the mercury may be achieved using any appropriate device configured for the electrolysis system such as a pump (e.g., rotary lobe, rotary gear, piston, screw, diaphragm, etc.), impeller, propeller, and/or a stir bar. In one embodiment, a stir bar is utilized because of the ease of integrating a stir bar in the electrolysis device.

Results to date suggest that the flow device should be selected, configured, and operated to sufficiently flow the mercury so as to limit or prevent the formation of the inhibitory reaction product layer without moving amalgamated solids from the bottom of the mercury cathode (or disturbing the amalgamated solids) because doing so tends to alter the pH of the system. For example, one may refresh the mercury cathode with a surface area of 78.5 cm², without stirring-up the amalgamated solids, by rotating a PEEK encapsulated cylindrical rare earth (NdBFe) magnet having dimensions of 3.56 cm in length and 1.14 cm in diameter (with a maximum energy product of 52 Mega Gauss Oersteds (MGO)) at a speed in a range of 280-300 rpm.

Selecting or controlling the surface area and the refresh rate of the surface area may be used to influence the rate of electrochemical separation of ytterbium from lutetium. For example, an increase in the surface area of the mercury cathode and electrolyte from 44 cm² to 78.5 cm² (the volume of electrolyte was maintained but the volume of mercury was increased from 76 cm³ to 101 cm³ to achieve the increased surface area in the reaction vessel, which was a cylindrical round bottom flask), while maintaining the flow of the mercury, increased the rate of the separation reflected in a 1^{st} order rate constant increasing from 0.045 to 0.12 min⁻¹. The flow was maintained using a 3.56 cm long×1.14 cm diameter stir bar located at the top of the mercury cathode and rotated at a rate in the range of 280-300 rpm. The platinum anode was changed but experiments varying the anode surface area and the anode-cathode spacing showed that the difference in performance was due to the increased surface area of the cathode-electrolyte interface. Also, the circulation rate of the electrolyte seemed to have little effect on the efficiency of the electrolytic separation. Further still, because more than an adequate amount of Yb was amalgamated in the lesser volume of mercury, the capacity of the mercury was not a controlling factor. Stated another way, the increase in the separation efficiency is believed to be due, almost entirely, to the rate at which the surface area of the mercury cathode was refreshed. The surface area of the mercury cathode may be selected from a range about 40 to 120, 60 to 100, or 70 to 90, or 75 to 85 cm². The speed of stirring may be selected from a range of 200 to 400, 250 to 350, 260 to 320, or 280 to 300 rpm.

The present disclosure also relates to a method of separating a product lanthanide and a non-product lanthanide that are in a mixture, the method comprising dissolving the product lanthanide and the non-product lanthanide that are in a mixture by a solvent comprising trifluoro-methane sulfonic acid and electrolyzing the mixture. In one embodiment, the solvent comprising trifluoro-methane sulfonic acid has concentration in a range of 3 M to 4 M. In another embodiment, the solvent comprising trifluoro-methane sulfonic acid has a concentration in a range of 3.2 M to 3.6 M. The use of this acid avoids the disadvantages of the use of hydrochloric acid or other chloride sources, which tend to erode the platinum electrode and oxidize the mercury thereby limiting re-use of the electrodes, in particular re-use of the mercury cathode.

In a specific embodiment, the present disclosure relates to a method of separating a product lanthanide and a non-product lanthanide that are in a mixture, the method comprising:
(a) providing an electrochemical cell, wherein the electrochemical cell comprises:
   a mercury cathode;
   an anode; and
   an initial electrolyte solution comprising alkali metal ions from an alkali metal salt dissolved in an initial solvent comprising water, wherein the initial electrolyte solution is in contact with the mercury cathode and the anode; and
(b) adding a second solution to the initial electrolyte solution in the electrochemical cell to form a separation electrolyte solution that is in contact with the mercury cathode and the anode, wherein the second solution comprises:
   a mixture comprising the product lanthanide and the non-product lanthanide; and
   a second solvent capable of dissolving said mixture comprising the product lanthanide and the non-product lanthanide without reacting with the anode and the mercury cathode;
(c) separating the non-product lanthanide from the separation electrolyte solution, wherein said separating comprises operating the electrochemical cell to:
   reduce the oxidation state of at least a portion of the non-product lanthanide, and amalgamate the reduced non-product lanthanide with the mercury of the mercury cathode without significantly incorporating the product lanthanide in the mercury cathode; and
   recovering a product solution that comprises dissolved product lanthanide; thereby separating product lanthanide and non-product lanthanide.

In one specific embodiment, the method of separating a product lanthanide and a non-product lanthanide may comprise a step of ion exchange using an anionic exchange resin and aqueous hydrochloric acid, thereby separating at least a portion of dissolved mercury ions.

In one specific embodiment, the method of separating a product lanthanide and a non-product lanthanide may comprise a step of chromatographic separation of product lanthanide, non-product lanthanide and alkali metal ions.

The present disclosure also relates to a method of producing a solution of a product lanthanide, preferably a non-carrier-added (n.c.a) product lanthanide solution, more preferably n.c.a. 177Lu, said method comprising:
providing a mixture comprising a product lanthanide and non-product lanthanide;
separating the product lanthanide and non-product lanthanide according to a separation method as described herein;
wherein, after the step of chromatographic separation, the eluates comprising the product lanthanide are concentrated in inert atmosphere; and
a solution comprising a product lanthanide, preferably non-carrier added (n.c.a) product lanthanide solution, more preferably n.c.a ¹⁷⁷Lu is recovered.

### BRIEF DESCRIPTION OF THE FIGURES

FIG. 1 is a graph of the percentage recovery of Yb as a function of time.

FIG. 2 is a graph of the natural log of the recovery of Yb as a function of time.

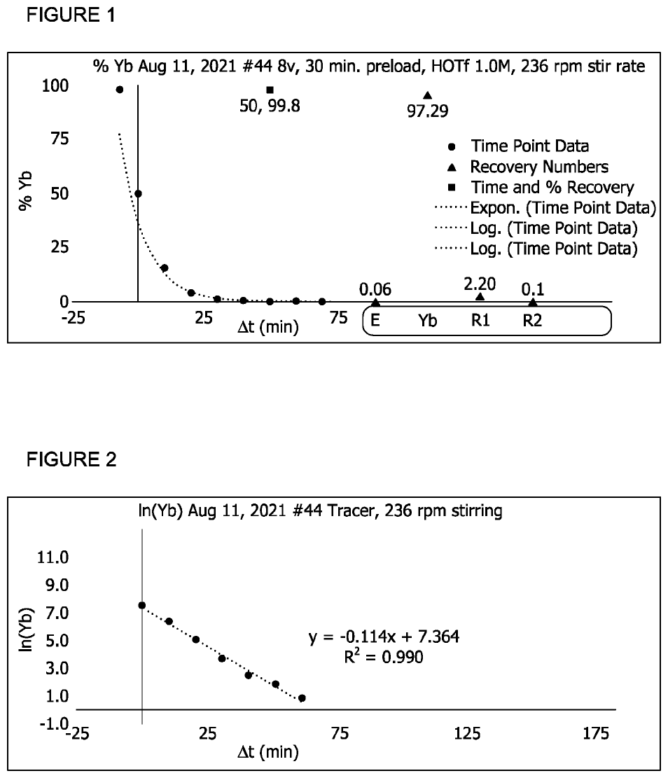

### DETAILED DESCRIPTION

### The Step of Electrolysis

The method of separation of the instant disclosure achieves separation of product lanthanide from non-product lanthanide starting from a mixture comprising the product lanthanide and the non-product lanthanide. The method of separating a product lanthanide and non-product lanthanide of the instant disclosure comprises a step of electrolysis employing an electrochemical cell.

In a specific embodiment, the method of separating a product lanthanide and a non-product lanthanide that are present in a mixture comprises the steps of:
(a) providing an electrochemical cell, wherein the electrochemical cell comprises:
   a mercury cathode,
   an anode, and
   an initial electrolyte solution comprising alkali metal ions from an alkali metal salt dissolved in an initial solvent comprising water, wherein the initial electrolyte solution is in contact with the mercury cathode and the anode, and
(b) adding a second solution to the initial electrolyte solution in the electrochemical cell to form a separation electrolyte solution that is in contact with the mercury cathode and the anode, wherein the second solution comprises a mixture comprising the product lanthanide and the non-product lanthanide, and a second solvent capable of dissolving said mixture comprising the product lanthanide and non-product lanthanide without reacting with the anode and the mercury cathode,
(c) separating the non-product lanthanide from the separation electrolyte solution, wherein said separating comprises:
   operating the electrochemical cell to reduce the oxidation state of at least a portion of the non-product lanthanide, and amalgamate the reduced non-product lanthanide in the mercury cathode without significantly incorporating the product lanthanide in the mercury cathode; and—recovering a product solution that comprises dissolved product lanthanide;
thereby separating product lanthanide and non-product lanthanide.

In an example of the present method, the product lanthanide is lutetium (Lu) and the non-product lanthanide is ytterbium (Yb). In an example of the present method, the product lanthanide is the radionuclide ¹⁷⁷Lu and the non-product lanthanide is ¹⁷⁶Yb.

In specific embodiments, the mixture comprising the product lanthanide and the non-product lanthanide may be of any origin. In an example, said mixture may be an irradiated target that comprises said mixture as oxides. The irradiated oxide target may have a mass in a range of about 0.5 g to 10 g and a radioactivity in a range of about 555 GBq to about 15000 GBq. The irradiated oxide target may be generated by applying neutron irradiation to a target of ¹⁷⁶Yb, preferably enriched ¹⁷⁶Yb, and allowing the target to decay to produce ¹⁷⁷Lu via beta-decay of the short lived radioisotope ¹⁷⁷Yb (half-life of 1.9 hours). In an example, the ¹⁷⁶Yb target comprises ytterbium oxide (Yb₂O₃).

Thus, in an example, the mixture comprising product lanthanide and non-product lanthanide may be an irradiated target comprising a mixture of ¹⁷⁷Lu and ¹⁷⁶Yb. In an example, said mixture may comprise ¹⁷⁷Lu and ¹⁷⁶Yb as the oxides, i.e., ¹⁷⁷Lu₂O₃ and ¹⁷⁶Yb₂O₃.

In specific embodiments, the mixture comprising product lanthanide and non-product lanthanide may have a mass ratio of non-product lanthanide to product lanthanide of about 1000:1 to about 4000:1. In specific embodiments, the mixture comprising the product lanthanide ¹⁷⁷Lu and non-product lanthanide ¹⁷⁶Yb may have a mass ratio of ¹⁷⁶Yb to ¹⁷⁷Lu of about 1000:1 to about 4000:1.

In step (a) of the present method, an electrochemical cell is provided which comprises a mercury cathode, an anode and an initial electrolyte solution. The mercury cathode comprises at least 99% by weight mercury. The mercury cathode may be about 99.999% by weight mercury. The mercury cathode may occupy the lower part of the electrochemical cell.

As the mercury cathode is liquid, it may be stirred. The mercury cathode may be stirred at the level of the upper surface of the mercury cathode. Alternatively, it may be stirred at mid-height level of the mercury cathode during operation. The mercury cathode may be stirred with a stir bar such as a PEEK encapsulated cylindrical rare earth (NdBFe) magnet (3.56 cm long×1.14 cm diameter) that has a maximum energy product of 52 Mega Gauss Oersteds (MGO) at a speed in a range of 280-300 rpm for a mercury cathode having a surface area of 78.5 cm². The surface area of the mercury cathode may be selected from a range about 40 to 120, 60 to 100, or 70 to 90, or 75 to 85 cm². The speed of stirring may be selected from a range of 200 to 400, 250 to 350, 260 to 320, or 280 to 300 rpm.

The anode comprises a metal (i.e., an anode metal) selected from the group consisting of ruthenium, rhodium, palladium, osmium, iridium, platinum, and alloys, mixtures or combinations thereof. Preferably, the anode comprises platinum. In specific embodiments, the anode may have a surface area in a range of about 10 to 40 cm², preferably 25 to 35 cm². In specific embodiments, the anode may comprise platinum having a surface area in the range of about 10 to 40 cm², preferably 25 to 35 cm². The anode is disposed in the initial electrolyte solution.

The initial electrolyte solution comprises alkali metal ions originating from an alkali metal salt dissolved in an initial solvent comprising water, wherein the initial electrolyte solution is in contact with the mercury cathode and the anode. The alkali metal ion may be selected from the group consisting of lithium ion, sodium ion, potassium ion. Lithium ions may be preferred.

In specific embodiments, the initial electrolyte solution may have an alkali metal ion concentration in a range of about 0.15 M to 0.90 M, more preferably in a range of about 0.30 M to 0.75 M, most preferably in a range of about 0.40 to 0.60 M in aqueous solvent.

In specific embodiments, the alkali metal salt may be selected from the group consisting of alkali metal tartrate, alkali metal acetate, alkali metal citrate, and combinations thereof.

Preferably the alkali metal salt is lithium citrate.

In specific embodiments, the initial electrolyte solution may comprise lithium ions at a concentration of about 0.40 to 0.6 M derived from lithium citrate dissolved in water, wherein the aqueous lithium citrate solution has a concentration of about 0.133 M to 0.25 M.

The cathode and the anode are connected to a power source provided outside and separate from the electrochemical cell by wiring which is known to the person skilled in the art. For example, ETFE coated wires may be selected because of their resistance to degradation when exposed to chemicals used in the electrolytic separation and radiation.

In specific embodiments, in step (b) of the present method, a second solution is added to the initial electrolyte solution in the electrochemical cell to form a separation electrolyte solution that is in contact with the mercury cathode and the anode. Said second solution comprises a mixture of the product lanthanide and the non-product lanthanide as described above, and a second solvent capable of dissolving said mixture comprising the product lanthanide and the non-product lanthanide without reacting with the anode and the mercury cathode. In specific embodiments, the second solvent may be tri-fluoro-methane sulfonic acid. In specific embodiments, the concentration of the second solvent that is used to dissolve the mixture may be 3 to 4 M, preferably 3.2 to 3.6 M in aqueous medium.

The advantage of using tri-fluoro-methane sulfonic acid as a second solvent is that undesired side-reactions with the cathode or the anode are suppressed or even avoided, which contributes to increasing the yield of the step of electrolysis and amalgamation and reducing impurities. In particular, said acid avoids erosion of the platinum anode and oxidation of the mercury cathode, as had been observed with hydrochloric acid or other chloride sources conventionally used, so that multiple re-use of the anode and mercury cathode is feasible.

In specific embodiments, step (b) of the present method may further comprise dissolving said mixture comprising the product lanthanide and the non-product lanthanide in the second solvent within a dissolution container, wherein the step of adding the second solution to the initial electrolyte solution comprises adding the contents of the dissolution container to the initial electrolyte solution.

In specific embodiments, step (b) may further comprise rinsing the dissolution container with a volume of a rinse solution, wherein the rinse solution comprises a dissolved lithium salt as described above and wherein the step of adding the other solution to the initial electrolyte solution further comprises adding said volume of the rinse solution used to rinse the dissolution container to the initial electrolyte solution. The rinse solution may be an aqueous 1.0-1.5 M lithium citrate solution.

In step (c) of the method, the product lanthanide is separated from the separation electrolyte solution generated in step (b). Step (c) of separating the product lanthanide from the separation electrolyte solution comprises:
operating the electrochemical cell to reduce the oxidation state of at least a portion of the non-product lanthanide, and amalgamate the reduced non-product lanthanide in the mercury cathode without significantly incorporating the product lanthanide in the mercury cathode; and
recovering a product solution that comprises dissolved product lanthanide;
thereby separating product lanthanide and non-product lanthanide.

The electrochemical cell may be operated under an inert atmosphere while agitating/flowing/circulating the mercury cathode. Operating under an inert atmosphere may comprise letting an inert gas bubble through the separation electrolyte solution or purging the headspace of the electrochemical cell. Preferably, an inert gas may be bubbled through the separation electrolyte solution. The inert gas may be argon. The inert atmosphere has about atmospheric pressure.

Agitating the mercury cathode may comprise stirring at the level of the upper surface of the mercury cathode or at mid-height level of the mercury cathode.

In specific embodiments, reducing the oxidation state of at least a portion of the non-product lanthanide may comprise reducing ytterbium (III) cations (Yb³⁺) and amalgamation of the ytterbium metal in the cathode.

Typically, reducing the oxidation state of at least a portion of the non-product lanthanide may comprise reducing isotope 176 ytterbium (III) cations (Yb³⁺) and amalgamation of the isotope 176 ytterbium metal in the cathode.

In specific embodiments, reducing the oxidation state of at least a portion of the non-product lanthanide may comprise operating the electrochemical cell in a single, continuous operation until at least 90% by weight, preferably 99% by weight, of the non-product lanthanide is reduced and amalgamated in the cathode.

Step (c) comprises operating the electrochemical cell at a separating pH of about 6.0 to about 7.0, preferably 6.5. In specific embodiments, step (c) comprises operating the electrochemical cell at a separating pH that is in a range of about 6.0 to about 7.0 at a separating temperature in a range of about 10° C. to about 30° C., a separating electrical potential in a range of about 5 V to about 10 V, and a separating electrical current in a range of about 1 amps to about 4 amps for a separating duration in a range of about 0.5 hours to about 4 hours.

For example, step (c) may comprise operating the electrochemical cell at a separating pH that is in a range of about 6.3 to about 6.7, a separating temperature in a range of about 15° C. to about 30° C., a separating electrical potential in a range of about 7 V to about 9 V, and a separating electrical current in a range of about 1.5 amps to about 3.5 amps for a separating duration in a range of about 1.5 hours to about 2.5 hours.

In specific embodiments, step (c) may comprise operating the electrochemical cell at a separating temperature in a range of about 15° C. to about 30° C., a separating pH that is about 6.5, for a separating duration of about 2 hours, and at a separating electrical potential of about 8 V and a separating electrical current of about 2.5 amps.

The separating pH may be controlled during the step (c) via periodic, continuous or incremental additions of a base. The base may be an alkali metal hydroxide solution. The alkali metal hydroxide solution may be selected from the group consisting of lithium hydroxide, potassium hydroxide and sodium hydroxide. The solution may have a concentration of about 3 M. Preferably a lithium hydroxide solution, which may have a concentration of about 3 M, is used.

Typically, step (c) of operating the electrochemical cell achieves that less than 0.2% by weight of product lanthanide are incorporated in the cathode.

In specific embodiments, in step (c) a product solution is recovered that comprises dissolved product lanthanide; thereby separating product lanthanide and non-product lanthanide, wherein the product solution comprising the product lanthanide contains no more than a trace amount of mercury ions, preferably less than 20 ppm, more preferably less than 10 ppm of mercury ions. This is achieved by one single, continuous operation of the electrochemical cell.

### Step of Conditioning the Electrochemical Cell

The method of separating product lanthanide and non-product lanthanide of the present disclosure may additionally comprise a step of conditioning the electrochemical cell provided in step (a) before performing steps (b) and (c).

In specific embodiments, step (a) may comprise a step of conditioning the electrochemical cell as described above to
reduce the oxidation state of at least a portion of alkali metal ions contained in the initial electrolyte solution, and
amalgamate the reduced alkali metal with mercury of the mercury cathode,
so that the mercury cathode additionally comprises an alkali metal amalgam.

Accordingly, in specific embodiments, the step of conditioning the electrochemical cell may comprise conditioning the electrochemical cell under an inert atmosphere as described above under step (c). The inert atmosphere is typically applied for at least 30 min immediately preceding conditioning of the cathode. The electrochemical cell may be agitated as described above.

The pH during conditioning may be as described above under step (c). In specific embodiments, the step of conditioning the electrochemical cell may comprise a conditioning pH that is in a range of about 6.0 to about 7.0, a conditioning temperature in a range of about 10° C. to about 30° C., a conditioning electrical potential in a range of about 5 V to about 10 V, and at a conditioning electrical current in a range of about 1 amps to about 4 amps for a conditioning duration in a range of about 0.5 hours to about 2 hours.

For example, the step of conditioning the electrochemical cell may comprise a conditioning pH that is in a range of about 6.3 to about 6.7, a conditioning temperature in a range of about 15° C. to about 25° C., a conditioning electrical potential in a range of about 7 V to about 9 V, and a conditioning electrical current in a range of about 1.5 amps to about 3.5 amps for a conditioning duration in a range of about 0.5 hours to about 1.5 hours.

In specific embodiments, the step of conditioning the electrochemical cell may comprise a conditioning temperature in a range of about 15° C. to about 25° C., a conditioning pH that is at about 6.5, a conditioning electrical potential of about 8 V, and a conditioning electrical current of about 2 amps for a conditioning duration of about 1 hour.

In specific embodiments, the step of conditioning may comprise controlling the conditioning pH by addition of a base. The base may be as described above under step (c). The base may be added periodically or continuously. Preferred are incremental additions of a lithium hydroxide solution, which may have a concentration of about 3 M.

For example, reducing the oxidation state of at least a portion of the alkali metal ions, preferably lithium ions, may comprise achieving a concentration of reduced alkali metal (preferably elemental lithium) relative to mercury in a range of about 50 ppm to about 1000 ppm, preferably about 100 ppm to about 800 ppm, most preferably about 150 ppm to about 500 ppm when measured immediately after the conditioning.

The step of conditioning reduces the formation of impurities during electrolysis and affords a product solution comprising less impurities, thereby allowing for the electrolysis of step (c) to be run on a significantly larger scale than methods of the prior art. The mode of operation of the electrochemical cell also has the advantage that the mercury may be re-used multiple times without any negative impact on the process or the resulting product.

In a specific example, the electrolysis of the instant disclosure comprises the following features:
the product lanthanide is lutetium;
the non-product lanthanide is ytterbium;
the mercury cathode, prior to conditioning the electrochemical cell, is about 99.999% mercury; the anode comprises a metal selected from the group consisting of ruthenium, rhodium, palladium, osmium, iridium, platinum, and alloys, mixtures, or combinations thereof; the initial electrolyte solution has an alkali metal ion concentration in a range of about 0.15 M to about 0.90 M, and
the alkali metal salt selected from the group consisting of alkali metal tartrate, alkali metal acetate, alkali metal citrate, and combinations thereof;
said conditioning comprises operating the electrochemical cell under an inert atmosphere while agitating the cathode at a conditioning pH that is in a range of about 6.0 to about 7.0, a conditioning temperature in a range of about 10° C. to about 30° C., a conditioning electrical potential in a range of about 5 V to about 10 V, and at a conditioning electrical current in a range of about 1 amps to about 4 amps for a conditioning duration in a range of about 0.5 hours to about 2 hours;
the second solvent is tri-fluoro-methane sulfonic acid; and
the step (c) operation of the electrochemical cell comprises operating the electrochemical cell under an inert atmosphere while agitating the cathode at a separating pH that is in a range of about 6.0 to about 7.0 at a separating temperature in a range of about 10° C. to about 30° C., a separating electrical potential in a range of about 5 V to about 10 V, and a separating electrical current in a range of about 1 amps to about 4 amps for a separating duration in a range of about 0.5 hours to about 4 hours.

In another specific example, the electrolysis of the instant disclosure comprises the following features:
the product lanthanide is ¹⁷⁷Lu;
the non-product lanthanide is ¹⁷⁶Yb;
the mercury cathode, prior to conditioning the electrochemical cell, is about 99.999% mercury;
the anode comprises platinum, wherein the anode has a surface area in a range of about 10 cm² to about 40 cm²
the initial electrolyte solution has an alkali metal ion concentration in a range of about 0.30 M to about 0.75 M, the alkali metal salt is lithium citrate, and the initial solvent is water; said conditioning comprises operating the electrochemical cell under an inert atmosphere while agitating the cathode at a conditioning pH that is in a range of about 6.3 to about 6.7, a conditioning temperature in a range of about 15° C. to about 25° C., a conditioning electrical potential in a range of about 7 V to about 9 V, and a conditioning electrical current in a range of about 1.5 amps to about 3.5 amps for a conditioning duration in a range of about 0.5 hours to about 1.5 hours;
the second solvent is tri-fluoro-methane sulfonic acid at a concentration in a range of about 2 M to about 4 M; and
the step (c) operation of the electrochemical cell comprises operating the electrochemical cell under an inert atmosphere while agitating the cathode at a separating pH that is in a range of about 6.3 to about 6.7, a separating temperature in a range of about 15° C. to about 25° C., a separating electrical potential in a range of about 7 V to about 9 V, and a separating electrical current in a range of about 1.5 amps to about 3.5 amps for a separating duration in a range of about 1.5 hours to about 2.5 hours.

In another specific example, the electrolysis of the instant disclosure comprises the following features:
the product lanthanide is ¹⁷⁷Lu;
the non-product lanthanide is ¹⁷⁶Yb;
the mercury cathode, prior to conditioning the electrochemical cell, is about 99.999% mercury;
the anode is platinum, wherein the anode has a surface area in a range of about 25 cm² to about 35 cm²
the initial electrolyte solution has a lithium concentration in a range of 0.40 M to about 0.60 M, the lithium salt is lithium citrate, and the initial solvent is water;
said conditioning comprises operating the electrochemical cell under an inert atmosphere while agitating the cathode at a conditioning temperature in a range of about 15° C. to about 25° C., a conditioning pH that is at about 6.5, a conditioning electrical potential of about 8 V, and a conditioning electrical current of about 2 amps for a conditioning duration of about 1 hour;
the second solvent is tri-fluoro-methane sulfonic acid at a concentration in a range of about 3 M to about 3.5 M; and
the step (c) operation of the electrochemical cell comprises operating the electrochemical cell under an inert atmosphere while agitating the cathode at a separating temperature in a range of about 15° C. to about 25° C., a separating pH that is about 6.5, for a separating duration of about 2 hours, and at a separating electrical potential of about 8 V and a separating electrical current of about 2.5 amps

### Step of Ion Exchange

In specific embodiments, the method of the instant disclosure may comprise a step of ion exchange to reduce the concentration of dissolved mercury ions in solutions comprising dissolved product lanthanide.

Typically, the method may comprise a step of ion exchange of a solution comprising product lanthanide using an anionic exchange resin and aqueous hydrochloric acid, thereby reducing dissolved mercury in the solution. The solution fed into this step may comprise alkali metal ions, a trace amount of non-product lanthanide, and a trace amount of dissolved mercury ions, in addition to the product lanthanide.

In specific embodiments, the solution subjected to the step of ion exchange may be the product solution comprising product lanthanide finally obtained in step (c). Then, the step of ion exchange typically comprises:
i. adding a volume of a hydrochloric acid solution to the product solution to form an acidified solution;
ii. passing the acidified solution through an ion exchange column comprising an anion exchange resin so that mercury ions adsorb to the anion exchange resin to form a reduced-mercury solution that comprises dissolved product lanthanide, non-product lanthanide, and alkali metal ions; and
iii. passing a rinse through the ion exchange column after the passing of the acidified solution to collect remaining amounts of the product lanthanide, non-product lanthanide, and lithium within the ion exchange column; and
   wherein the reduced-mercury solution, said passed rinse, or the combination thereof is an ion exchange product solution.

For example, the hydrochloric acid solution may be an aqueous concentrated HCl solution, approximately 11.5 M. The anion exchange resin may be a styrene-divinylbenzene-based resin. The rinse may be an aqueous 0.15 M HCl solution.

Column had an inner diameter of 1 cm and a length of 10 cm; it was operated at ambient temperature at a rate of 3 mL/min, which was arrived at through empirical optimization.

While two or more steps of ion exchange may be run in parallel or in sequence, the method as per the instant disclosure should achieve sufficient mercury separation running just one, single step of ion exchange on the basis of one ion exchange column. Therefore, in certain embodiments, the step of ion exchange affords an ion exchange product solution which may have a concentration of mercury that is no greater than 10 ppb.

### Step of Chromatographic Separation

In specific embodiments, the method of the instant disclosure may further comprise a step of chromatographic separation to reduce the concentration of alkali metal ions, non-product lanthanide and mercury ions.

In preferred embodiments, the solution subjected to the step of chromatography may be the ion exchange product solution finally obtained in the ion exchange step. As indicated above, the ion exchange production solution may be the reduced-mercury solution, the passed rinse, or the combination thereof is an ion exchange product solution. In one embodiment, the reduced-mercury solution and the passed rinse are combined and the combination is subjected chromatographic separation. In another embodiment, the reduced-mercury solution and the passed rinse are subjected to chromatographic separation sequentially (e.g., by arranging the ion exchange and chromatographic columns in series).

Typically, the step of chromatographic separation may comprise:
i. loading the ion exchange product solution on a chromatography column comprising a chromatography resin capable of adsorbing product lanthanide and non-product lanthanide without adsorbing lithium ions thereby adsorbing product lanthanide and non-product lanthanide;
ii. washing the loaded chromatography column with a chromatography wash solution to remove alkali metal ions from the chromatography column without desorbing product lanthanide and non-product lanthanide from the chromatography resin; and
iii. passing a chromatography eluent solution through the washed chromatography column having adsorbed product lanthanide and non-product lanthanide, wherein the product lanthanide and non-product lanthanide desorb from the chromatography resin and separate as they travel through the column in the chromatography eluent solution at different rates according to their respective distribution coefficients for the column thereby separating the product lanthanide and the non-product lanthanide into product lanthanide-containing eluate and non-product lanthanide-containing eluate, respectively.

The chromatography resin may comprise an alkyl derivative of phosphoric acid on inert supports. The alkyl derivative of phosphoric acid may be selected from the group consisting of di(2-ethylhexyl)orthophosphoric acid (HDEHP), 2-ethylhexylphosphonic acid mono-2-ethylhexyl ester (HEH[EHP]), and di-(2,4,4-trimethylpentyl)phosphinic acid (H[TMPeP]).

The chromatography resin may alternatively comprise an alkylphosphoric acid alkyl ester on inert supports. The chromatography resin may comprise (2-ethylhexyl)phosphonic acid-(2-ethylhexyl)-ester (HEH[EHP]) on inert supports.

The chromatography wash solution may be an aqueous 0.15 M HCl solution; the chromatography eluent solution may be an aqueous 1.4 to 1.5 M HCl solution; and the chromatography column may be at a temperature in a range of about 40° C. to about 55° C., preferably about 45° C. to about 50° C. during the chromatographic separation process.

While the step of chromatographic separation may be performed after the step of ion exchange, chromatographic separation may alternatively be performed first, so that the product solution finally obtained in the step (c) of the instant method may be loaded onto the chromatography column of step i. above, and then ion exchange may be carried out.

Preferably, chromatographic separation is performed after the step of ion exchange.

While two or more steps of chromatographic separation may be run in parallel or in sequence, the method as per the instant disclosure achieves excellent separation running just one, single step of chromatographic separation on the basis of one chromatography column.

The step of chromatographic separation additionally separates mercury contained in the ion exchange product solution affording a product lanthanide-containing eluate having a concentration of mercury that is no greater than 1 ppb.

The resulting ¹⁷⁷Lu product has a specific activity that is >2900 GBq/mg, a high radiochemical purity (RCP) (>99%), and a radionuclide purity (RNP) (>99.9%).

### Step of Reformulation

The method of the instant disclosure may further comprise a step of reformulation of the solution obtained after chromatography/ion exchange.

The step of reformulation comprises reformulating the product lanthanide-containing eluate finally obtained in the step of chromatographic separation by heating the product lanthanide-containing eluate under an inert atmosphere to form a solid residue comprising product lanthanide.

In specific embodiments, the product lanthanide of the solid residue may be product lanthanide chloride hydrate. Typically, the product lanthanide of the solid residue may be ¹⁷⁷LuCl₃·nH₂O. The ¹⁷⁷LuCl₃·nH₂O has a specific activity in a range of about 2900 GBq/mg to about 4070 GBq/mg.

The solid residue may be redissolved (e.g., using a 0.05 M HCl solution) to a desired activity concentration.

### Step of Recovery of Non-Product Lanthanide

The method of the instant disclosure further comprises a step of recovering non-product lanthanide by:
contacting the mercury cathode and the electrochemical cell with an acid solution to extract non-product lanthanide therein to form a non-product lanthanide-containing solution;
precipitating non-product lanthanide from the purified non-product lanthanide-containing solution with oxalic acid to form non-product lanthanide oxalate salts; and
pyrolyzing the non-product lanthanide oxalate salts to form recovered non-product lanthanide oxide.

In specific embodiments, the acid solution may be selected from the group consisting of hydrochloric acid and trifluoro-methane sulfonic acid.

In specific embodiments, pyrolyzing may be carried out at a range of about 800° C. to about 850° C.

In specific embodiments, the precipitated non-product lanthanide oxalate salt may be thoroughly washed to remove lithium that may be present in the precipitate before the salt is pyrolyzed in air.

In specific embodiments, the non-product lanthanide oxalate salts are ¹⁷⁶Yb₂(Oₓ)₃ and the recovered non-product lanthanide oxide is ¹⁷⁶Yb₂O₃.

### Method of Producing a Solution of Product Lanthanide

The instant disclosure also concerns a method of producing a solution of a product lanthanide, preferably a non-carrier-added (n.c.a) product lanthanide solution, which is preferably n.c.a. ¹⁷⁷Lu. The method may comprise:
providing a mixture comprising a product lanthanide and non-product lanthanide;
separating the product lanthanide and non-product lanthanide according to the steps described hereinabove;
wherein after the step of chromatographic separation eluates comprising the product lanthanide are concentrated in inert atmosphere; and
a solution comprising a product lanthanide, preferably non-carrier added (n.c.a) product lanthanide solution, more preferably n.c.a ¹⁷⁷Lu is recovered.

The step of concentrating the eluates obtained after chromatographic separation may comprise mild conditions, such as evaporation by heating the solution under a stream of argon. The inert atmosphere may be provided by argon or nitrogen.

In specific embodiments, the solution that is recovered as product of the process may comprise more than 98% non-carrier added (n.c.a) product lanthanide, preferably more than 99% n.c.a. ¹⁷⁷Lu. In particular, the solution that is recovered as product of the process may comprise more than 98% non-carrier added (n.c.a) product lanthanide, preferably more than 99% n.c.a. ¹⁷⁷Lu with a specific activity of >2900 GBq/mg.

In specific embodiments, the above method of producing may comprise providing about 0.5 to 10 g and about 555 GBq to 15000 GBq of a mixture of product and non-product lanthanides. The mixture of product lanthanides and non-product lanthanides may have been generated by applying neutron irradiation to a target of ¹⁷⁶Yb, preferably ytterbium oxide, to generate the radioisotope ¹⁷⁷Yb, and allowing the target to decay to produce ¹⁷⁷Lu from ¹⁷⁷Yb after beta-decay.

### EXAMPLES

The objectives of the chemical process are to (a) separate trace (mg) levels of Lu from bulk (gram) levels of Yb and (b) to recover in high yield the Yb from the process. The separation is achieved by reducing the Yb into a mercury cathode and then using chromatography to separate trace amounts of Yb from the Lu in the electrolyte solution. The Yb target material is recovered from the mercury cathode by extraction with triflic acid followed by precipitation with oxalic acid and ashing of the oxalate compound to Yb oxide.

The electrochemical cell (EC) consisted of a mercury cathode, platinum anode, and 0.16 M lithium citrate electrolyte. After sufficient purging with argon to eliminate oxygen, the EC cell is operated at 8.0 V for 30 minutes with the pH controlled at 6.5 by LiOH addition to create a lithium mercury amalgam. The Yb₂O₃ target is dissolved in triflic acid and then added to the EC cell and electrolysis continued until the Yb concentration is reduced by at least 99% through reductive amalgamation. During electrolysis, the EC cell is maintained at a temperature of 20 degrees Celsius, the surface of the cathode is continuously stirred, the pH of the solution is maintained at 6.5 with the continual addition of LiOH, and the EC is continuously purged with argon gas.

Once the desired Yb separation is achieved, the electrolyte solution is removed from the EC. The electrolyte solution is filtered and acidified with the addition of HCl acid. The electrolyte solution is then passed through an anion exchange resin that has been pre-equilibrated with HCl to remove trace amounts of mercury from the solution.

The solution from the anion exchange resin is then loaded on to an LN2 resin where the trace amount of Yb in the solution is separated from the Lu in the solution by elution with 1.4 M HCl. The LN2 column is maintained at a temperature of 50° C. for the separation process.

The Yb elutes from the column first, then the Lu is eluted and collected. The Lu eluant is dried down and reconstituted in 0.05 M HCl to create the desired activity concentration for the product. The enriched Yb target material is recovered from the mercury cathode by washing with triflic acid. The Yb in the triflic acid recovery solution is precipitated with the addition of oxalic acid. The ytterbium oxalate is converted back into ytterbium oxide target material by ashing (or pyrolyzing) the precipitate to 850° C.

### Apparatus, Materials and Detailed Steps

An electrochemical cell was provided having a volume of 1000 mL and a 10-cm diameter.

The electrochemical cell had a round bottom and was water-jacketed. It held about 1360 g mercury (cathode) and a NdBFe magnet. It was equipped with a PEEK lid with fittings Pt (platinum) electrodes (anode and cathode contact), a pH recirculation reservoir and tubing, argon bubbler, LiOH (lithium hydroxide) dispensing line and a vent/access hole.

A Dowex 1×8 (Cl-) column (1 cm diameter, 10 cm long) equilibrated in 0.15 M HCl was used for the ion exchange.

A water-jacketed LN2 column (1.1 cm diameter, 40 cm long) equilibrated in 0.15 M HCl was used for the chromatographic separation. The LN2 column contains a (2-ethylhexyl)phosphonic acid-(2-ethylhexyl)-ester (HEH[EHP]) on inert support as stationary phase.

### 1. Target Dissolution:

a. An irradiated Yb₂O₃ target was transferred from a quartz target vial to a target dissolution vial.
b. 3.4 M Triflic acid (tri-fluoro methane sulfonic acid) was added to the dissolution vial. The target sample solution was heated at around ˜100° C. under continuous stirring until target material was completely dissolved.
c. Once dissolved, the target solution was allowed to cool to room temperature.

### 2. Electrochemical Cell Preparation

a. The thermostated recirculator was set to 20° C. and the flow to the jacketed electrochemical cell was started.
b. 187 grams of 0.16 M lithium citrate electrolyte solution were added to the electrochemical cell.
c. A slow argon purge of the electrochemical cell was initiated and stirring of the surface of the mercury cathode was started.
d. The peristaltic pump was turned to slowly recirculate the electrolyte through the pH loop. The flow rate was adjusted such that the return electrolyte drips steadily into the electrochemical cell but does not form a continuous stream.
e. During electrolysis, the pH was maintained at 6.5 by continuous addition of 3.0 M LiOH.
f. The electrolyte solution was purged with argon for at least 30 minutes before start of electrolysis and continuously through the electrochemical process.

### 3. Electrolysis

a. After at least 30 minutes argon purge, pre-electrolysis was initiated at a potential of 8.0-8.1 V.
b. During pre-electrolysis, the argon purge was continued and pH was maintained at 6.5 by incremental addition of 3.0 M LiOH.
c. The pre-electrolysis was continued for ˜30 minutes.
d. After thirty minutes of pre-electrolysis, the target solution was added without halting electrolysis.
e. Electrolysis was continued until >99% Yb reduction in the electrolyte solution was achieved. The pH was maintained during electrolysis at 6.5 by LiOH addition.
f. At completion of electrolysis, rapidly the following steps were carried out:
   1. Halt the addition of LiOH.
   2. Raise the pH loop sipper tube above the liquid level in the electrochemical cell and allow the line to clear with pumping.
   3. Raise the argon purge line above the liquid level.
   4. Stop the magnetic stirrer.
   5. Rapidly vacuum transfer the electrolyte from the electrochemical cell to a receiver bottle being careful to not aspirate any mercury with the solution.
g. Then the transferred electrolyte was filtered through a 0.2 micron PES membrane and into a 250 mL Nalgene bottle.
h. 7.0 mL of conc. HCl were added to the filtered electrolyte.

### 4. Chromatographic Purification

a. The water recirculation through the LN2 column jacket was set to 50° C. to heat the column before electrolyte input to the Dowex-LN2 column series. The output of the Dowex ion exchange column is connected in series to the input of the LN2 column.
b. The pH-adjusted electrolyte solution was loaded onto the Dowex 1×8 column and through to the LN2 column at a flow rate of 2 to 3 mL/min.
c. The chromatography system was rinsed with 70 mL of 0.15 M HCl at a flow rate of 2 to 3 mL/min.
d. The LN2 column was rinsed with 150 mL of 0.15 M HCl at a flow rate of 2 to 3 mL/min. e. Trace of Yb and Lu product was eluted from the LN2 column using 1.4 M HCl. The Yb elutes in the first ˜200 mL followed by Lu, thereby obtaining the product solution comprising dissolved lutetium.

### 5. Post Electrolysis Yb Recovery

a. 200 mL of 1.0 M Triflic acid were added to the electrochemical cell and gently stirred to clean the anode electrode.
b. The anode electrode was raised to the top of the EC cell and then the acid extractant was vigorously stirred for ˜30 minutes.
c. Vacuum transfer of the Triflic acid recovery solution from the EC cell to a 500 mL Nalgene bottle was performed. This bottle contained the Yb target material.
d. 100 mL of 0.05 M Triflic acid rinse solution were added to the electrochemical cell and stirred vigorously for ˜10 minutes.
e. Vacuum transfer of the Triflic acid rinse solution to the Triflic acid recovery solution was performed.
f. The combined Triflic acid recovery/rinse solution was filtered through a 0.2 μm PES filter and into a Nalgene filter bottle.

### 6. Yb Target Recycling

a. After sufficient decay, Yb from the Triflic acid recovery/rinse solution was precipitated by adding 50% molar excess of oxalic acid to the solution.
b. The precipitate suspension was filtered through ashless filter paper, then the precipitate was washed with water.
c. The precipitate and filter paper were placed in a quartz vial and heated to ˜850° C. to decompose filter paper and convert Yb₂(C₂O₄)₃ to Yb₂O₃.

As illustrated in the figures below, the electrochemical separation of the Yb from the electrolyte solution follows first-order kinetics. Many of the electrochemical separation process parameters have been optimized to achieve a maximum rate for the separation process in order to minimize the time for the electrochemical separation. Minimizing the separation time increases the overall Lu yield from the process (by reducing the loss through radioactive decay) and minimizes the effects of radiolysis on the efficiency of the separation process. The rate constant k for the separation process is determined from the slope of the natural log of the Yb concentration in the electrolyte solution versus time. For example, 99% separation is achieved in 46 minutes for a process that has a rate constant of 0.10 min⁻¹ versus 92 minutes for a rate constant of 0.05 min⁻¹.

### 1. Baseline

Early development work on the process utilized what we termed the Prototype EC cell: 450 mL Ace Jacketed beaker for temperature control 7.48 cm ID (43.9 cm² Hg surface area) with a fabricated closure with compression fittings for electrodes, pH recirculation loop, LiOH dosing and argon purging.
After numerous small scale testing to rough out the process, 2.5 g Yb as Yb₂O₃/HOTf became the normal scale for optimization in the prototype cell. For all processes, tracer ¹⁷⁵Yb (˜370 MBq) was used for monitoring reaction progress by high-purity gamma spectroscopy. Tracer Lu-177 was also used when necessary to confirm complete recovery in the process.
A constant potential of 8.0 V D.C. was found to be optimum for best Yb separation in the prototype system.
Readily available Pt wire was used to fabricate the anode and cathode contact electrodes. Pt wire loop Anode (1 mm diameter by ˜50 cm); ˜908 g Hg cathode with Pt wire loop contact (1 mm diameter by ˜25 cm) (Anode/Cathode spacing was maintained at ˜1.5 cm)
Early testing optimized the process chemistry as follows: 187 mL 0.16 M lithium citrate electrolyte; 1 h pre-electrolysis and ˜2 h Yb electrolysis to achieve >99 Yb depletion in the electrolyte; pH was controlled throughout the process at 6.5 with 3.0 M LiOH
Preceding the process and continuous throughout, the electrochemical cell was purged with high purity argon;
The temperature was maintained at 20° C. during the process using a chilled water recirculation system.
Target addition, post pre-electrolysis, was followed by 10.0 g 1.33 M LiCit to achieve optimum Citrate/Yb ratio and 6.75 g 3.0 M LiOH to neutralize excess trifluoromethanesulfonic acid necessary for dissolution of the Yb₂O₃ target.
First-order rate constant (derived from plot of In(Yb-175) vs. time) k=0.0462 min⁻¹ (average of 11 runs)—equivalent to ˜99% Yb reduction in 100 minutes.

### 2. Process Capacity

Prototype EC, baseline system described above with increased target (5.0 g Yb) and tracer Yb-175.
Rate constant k=0.0324 min⁻¹ equivalent to 99% Yb reduction in ˜142 minutes
First 5.0 g test gave successful Yb reduction but suffered from mercury byproduct complications.
Prototype EC, baseline system with 25% extra LiCit, 25% extra Hg, and 5.0 g Yb with Yb-175 tracer.
Rate constant k=0.0333 min⁻¹ essentially equivalent Yb reduction but with significantly suppressed mercury byproducts.

### 3. Pre-Electrolysis

First high activity process (15 Ci Lu-177 and 0.5 g Yb) using prototype EC baseline system
Failed to achieve required 99% Yb reduction. Reached max −ΔYb at only 89.4%. Hypothesis: interference from radiolysis products such as hydrogen peroxide.
High activity (15 Ci Lu-177 and ˜0.5 g Yb) repeated with prototype ECbaseline system modified by (1) incorporation of a one hour pre-electrolysis step preceding target introduction, (2) addition of additional lithium citrate post target and (3) installation of a Pt mesh to catalyse hydrogen peroxide decomposition.
99% Yb separation achieved in 2 hours in three separate experiments; first order rate constants k≈0.055 min⁻¹
Hypotheses: (1) Because lithium amalgam plays an important role in the reduction and amalgamation of Yb, pre-loading the amalgam before target addition significantly accelerates the Yb reactions. This is supported by the observation of a higher rate constant during the start of the Yb electrolysis. (2) Additional lithium citrate, added immediately following target addition, aids in formation of the citrate—Yb complex favoring Yb electrolysis. (3) The added Pt mesh could potentially help minimize interferences from radiolysis products. We believe that the pre-loading of the lithium amalgam is predominant reason for the success of the process. This observation has not been reported in the literature.

### 4. Higher Concentration of Radiolytic Products

Due to apparent radiolysis issues with the 15 Ci Lu-177, 0.5 g Yb test, scale up to higher activity (70 Ci Lu-177, 2.35 g Yb) was an important step toward a full commercial process.
Small scale prototype EC cell baseline system utilized with pre-electrolysis loading of lithium amalgam
99% Yb separation was achieved with extension of electrolysis to 4 hours
The resultant rate constant (k=0.0162 min⁻¹) was significantly lower than for the prior 15 Ci Lu-177 process, confirming concern regarding high activity targets. Reminder: no such degradation in rate constants were observed in low-activity tracer tests over a large range of target sizes.

### 5. Process pH Optimization

Experiments were performed to determine the optimum pH for the Yb electrolysis using the small scale prototype-baseline system.
At controlled lower pH, Yb reductive amalgamation efficiency was reduced; e.g. at pH 6.0, the maximum Yb depletion in the electrolyte was 95%.
At higher pH (e.g. pH 7.0) interference from mercury compounds compromised the process.

### 6. Lithium Citrate Concentration Optimization

Using the small-scale prototype baseline system, lithium citrate concentration was varied from 0.16 M to 0.32 M
Rate constants were best at a lithium citrate concentration of 0.16 M. [LiCit]=0.16 M k=0.0482 min⁻¹; [LiCit]=0.24 M k=0.0249 min⁻¹; [LiCit]=0.32 M k=0.0189 min⁻¹

### 7. Electrochemical Cell Potential Optimization

Using the small-scale prototype baseline system, the cell potential was varied from 7.0 to 9.0 V
Rate constants indicated that a potential of 8.0 V was ideal. 7.0 V k=0.0236 min⁻¹; 8.0 V k=0.0482 min⁻¹; 9.0 V k=0.0317 min⁻¹
In addition to process efficiency, i.e., rate constants, potentials higher than 8.0 V caused issues with mercury by products.

### 8. Beta Baseline

Limitations in the small-volume prototype electrochemical cell led us to explore versions more appropriate for routine production and with improved process efficiency, i.e. larger Yb depletion rate constants.
The result of the search was the Beta Version EC cell: 1000 mL Ace Jacketed round-bottom flask 10.0 cm ID with larger volume and greater mercury cathode surface area (78.5 cm²).
Multiple tracer tests (2.5 g Yb as Yb₂O₃/HOTf with 370 MBq of ¹⁷⁵Yb) were performed to refine the process and associated equipment.
Beta Version EC cell parameters:
   Electrodes: 6 mm wide Pt ribbon Anode (˜7.6 cm diameter); ˜1300 g Hg cathode with ˜5 cm long Pt wire contact (Anode/Cathode spacing ˜1.25 cm)
   Cathode surface stirring at 270 rpm with PEEK encapsulated RE magnet
Process parameters:
   187 mL 0.16 M LiCit; 30 minute pre-electrolysis; pH controlled at 6.5 with 3.0 M LiOH
   Pre-process and continuous argon purge; temperature maintained at 20° C.
   Yb target addition followed by 10.0 g 1.33 M LiCit to maintain proper Citrate/Yb ratio and 6.75 g 3.0 M LiOH to neutralize excess acid and adjust system to proper pH.
Rate constants were significantly improved compared to the prototype system experiments k=0.124±0.005 min⁻¹ (n=6)
Hypothesis: Significant increase in the rate constant is predominantly a result of the larger surface area of the mercury cathode in the beta version of the E cell
   9. Acid Used for Recovering Yb from Mercury Cathode
In the baseline studies with the Beta Version EC cell, the Yb target material was recovered from the mercury cathode at the conclusion of the process by extraction with 2.25 M HCl. beta baseline, Yb recovery using 2.25 M HCl, recycled mercury
As in the small-scale prototype testing, mercury was recovered after each process, rinsed with water and then cleaned before recycling for the subsequent test.
In the baseline Beta Version testing, recycled mercury was visibly degraded by buildup of mercury chloride and mercury platinum compounds over the course of four consecutive runs. This was visible in compromised appearance and reflected in the rate constants for four sequential processes.
Run 1 k=0.104 min⁻¹; Run 2 k=0.131 min⁻¹; Run 3 k=0.083 min⁻¹; Run 4 k=0.066 min⁻¹
We hypothesized that the hydrochloric acid was causing these deleterious effects due to the formation of chlorine which reacted with the mercury and platinum anode to form oxidation products.
We subsequently evaluated the substitution of trifluoromethane sulfonic acid for the Yb target recovery and found that it eliminated contamination of the recycled mercury and degradation of the platinum anode. It was also discovered through exhaustive testing that the concentration of acid could be lowered to 1.0 M.
   In twelve consecutive tracer tests with 2.5 g Yb targets, no visible degradation of the mercury was observed and the rate constants demonstrated high reproducibility k=0.125±0.006 min⁻¹ (n=12)

### 10. Stir Rate of Surface of Mercury Cathode

Renewal of the surface of the mercury cathode through controlled stirring was found to be a critical parameter to process efficiency in the Beta Version EC cell, As an example, with the stir rate lowered from 270 rpm to 190 rpm, the Yb depletion rate constant decreased form k=0.125 min⁻¹ to k=0.058 min⁻¹
Note that stirring must take place on the surface of the mercury. At too high a stir rate, the stir bar can become immersed in the mercury and thus disturb the amalgams formed under the surface.

### EMBODIMENTS

1. A method of separating a product lanthanide and a non-product lanthanide that are in a mixture, the method comprising:
   a. providing an electrochemical cell, wherein the electrochemical cell comprises:
      i. a mercury cathode;
      ii. an anode; and
      iii. an initial electrolyte solution comprising alkali metal ions from an alkali metal salt dissolved in an initial solvent comprising water, wherein the initial electrolyte solution is in contact with the mercury cathode and the anode; and
   b. adding another solution to the initial electrolyte solution in the electrochemical cell to form a separation electrolyte solution that is in contact with the mercury cathode and the anode, wherein the other solution comprises:
      i. a mixture comprising the product lanthanide and the non-product lanthanide; and
      ii. a second solvent capable of dissolving said mixture comprising the product lanthanide and the non-product lanthanide without reacting with the anode and the mercury cathode;
   c. separating the non-product lanthanide from the separation electrolyte solution, wherein said separating comprises operating the electrochemical cell to:
      i. reduce the oxidation state of at least a portion of the non-product lanthanide, and
      ii. amalgamate the reduced non-product lanthanide with the mercury of the mercury cathode; and
      iii. recovering a product solution that comprises dissolved product lanthanide; thereby separating product lanthanide and non-product lanthanide.
2. The method of Embodiment 1, wherein the step (a) of providing an electrochemical cell comprises a step of conditioning the electrochemical cell to: reduce the oxidation state of at least a portion of the alkali metal ions, and amalgamate the reduced alkali metal with mercury of the mercury cathode so that the mercury cathode additionally comprises an alkali metal amalgam.
3. The method of Embodiment 1 or 2, wherein the product lanthanide is lutetium and the non-product lanthanide is ytterbium.
4. The method of any one of Embodiments 1 to 3, wherein the product lanthanide is ¹⁷⁷Lu and the non-product lanthanide is ¹⁷⁶Yb.
5. The method of any one of Embodiments 1 to 4, wherein the mercury cathode, prior to conditioning the electrochemical cell according to Embodiment 2 or step (b) of Embodiment 1, is about 99.999% mercury.
6. The method according to any of Embodiments 1 to 5, wherein the anode comprises a metal selected from the group consisting of ruthenium, rhodium, palladium, osmium, iridium, platinum, and alloys, mixtures, or combinations thereof.
7. The method according to Embodiment 6, wherein the anode comprises platinum.
8. The method according to Embodiment 6 or 7, wherein the anode has a surface area in a range of about 10 cm² to about 40 cm², preferably a range of about 25 cm² to about 35 cm².
9. The method according to any Embodiments of 1 to 8, wherein the cathode has a surface area of 40 cm² to 120 cm², preferably 60 cm² to 100 cm², more preferably 70 cm² to 90 cm², most preferably 75 cm² to 85 cm².
10. The method according to any of Embodiments of 1 to 9, wherein the cathode is stirred at a rate of 200 to 400 rpm, preferably 250 to 350 rpm, more preferably 260 to 320 rpm, most preferably 280 to 300 rpm.
11. The method according to any of Embodiments 1 to 10, wherein the initial electrolyte solution has a alkali metal ion concentration in a range of about 0.15 M to about 0.90 M, more preferably 0.30 M to 0.75 M, most preferably 0.40 M to 0.60 M.
12. The method according to any of Embodiments 1 to 11, wherein the alkali metal ion is selected from the group consisting of lithium, sodium, potassium ions, preferably lithium ions.
13. The method according to any of Embodiments 1 to 12, wherein the alkali metal ions originate from an alkali metal salt selected from the group consisting of alkali metal tartrate, alkali metal acetate, alkali metal citrate, and combinations thereof.
14. The method according to any of Embodiments 1 to 13, wherein the alkali metal salt is lithium citrate.
15. The method according to any of Embodiments 2 to 14, wherein said step (a) comprises conditioning the electrochemical cell under an inert atmosphere.
16. The method according to any of Embodiments 2 to 15, wherein said step (a) comprises conditioning the electrochemical cell while agitating the cathode at a conditioning pH that is in a range of about 6.0 to about 7.0, a conditioning temperature in a range of about 10° C. to about 30° C., a conditioning electrical potential in a range of about 5 V to about 10 V, and at a conditioning electrical current in a range of about 1 amps to about 4 amps for a conditioning duration in a range of about 0.5 hours to about 2 hours.
17. The method according to any of Embodiments 1 to 16, wherein the second solvent is trifluoromethane sulfonic acid.
18. The method according to Embodiment 17, wherein the concentration of the second solvent is 2 M to 4 M, preferably 3 to 3.5 M.
19. The method according to any of Embodiments 1 to 18, wherein the step (c) comprises operating the electrochemical cell under inert atmosphere while agitating the cathode.
20. The method according to any of Embodiments 1 to 19, wherein the step (c) comprises operating the electrochemical cell at a separating pH that is in a range of 6.0 to 7.0, preferably 6.5.
21. The method according to any of Embodiments 1 to 21, wherein the step (c) comprises operating the electrochemical cell at a separating pH that is in a range of about 6.0 to about 7.0 at a separating temperature in a range of about 10° C. to about 30° C., a separating electrical potential in a range of about 5 V to about 10 V, and a separating electrical current in a range of about 1 amps to about 4 amps for a separating duration in a range of about 0.5 hours to about 4 hours.
22. The method of Embodiment 1, wherein:
   the product lanthanide is lutetium;
   the non-product lanthanide is ytterbium;
   the mercury cathode, prior to conditioning the electrochemical cell, is about 99.999% mercury;
   the anode comprises a metal selected from the group consisting of ruthenium, rhodium, palladium, osmium, iridium, platinum, and alloys, mixtures, or combinations thereof;
   the initial electrolyte solution has a alkali metal ion concentration in a range of about 0.15 M to about 0.90 M, and the alkali metal salt selected from the group consisting of alkali metal tartrate, alkali metal acetate, alkali metal citrate, and combinations thereof; said conditioning comprises operating the electrochemical cell under an inert atmosphere while agitating the cathode at a conditioning pH that is in a range of about 6.0 to about 7.0; a conditioning temperature in a range of about 10° C. to about 30° C.; a conditioning electrical potential in a range of about 5 V to about 10 V, and at a conditioning electrical current in a range of about 1 amps to about 4 amps for a conditioning duration in a range of about 0.5 hours to about 2 hours;
   the second solvent is trifluoromethane sulfonic acid; and the step (c) comprises operating the electrochemical cell under an inert atmosphere while agitating the cathode at a separating pH that is in a range of about 6.0 to about 7.0 at a separating temperature in a range of about 10° C. to about 30° C., a separating electrical potential in a range of about 5 V to about 10 V, and a separating electrical current in a range of about 1 amps to about 4 amps for a separating duration in a range of about 0.5 hours to about 4 hours.
23. The method of Embodiment 1, wherein:
   the product lanthanide is ¹⁷⁷Lu;
   the non-product lanthanide is ¹⁷⁶Yb;
   the mercury cathode, prior to conditioning the electrochemical cell, is about 99.999% mercury;
   the anode comprises platinum, wherein the anode has a surface area in a range of about 10 cm² to about 40 cm²;
   the initial electrolyte solution has a alkali metal ion concentration in a range of about 0.30 M to about 0.75 M, the alkali metal salt is lithium citrate, and the initial solvent is water;
   said conditioning comprises operating the electrochemical cell under an inert atmosphere while agitating the cathode at a conditioning pH that is in a range of about 6.3 to about 6.7, a conditioning temperature in a range of about 15° C. to about 25° C., a conditioning electrical potential in a range of about 7 V to about 9 V, and a conditioning electrical current in a range of about 1.5 amps to about 3.5 amps for a conditioning duration in a range of about 0.5 hours to about 1.5 hours; the second solvent is trifluoromethane sulfonic acid at a concentration in a range of about 2 M to about 4 M; and
   the step (c) comprises operating the electrochemical cell under an inert atmosphere while agitating the cathode at a separating pH that is in a range of about 6.3 to about 6.7, a separating temperature in a range of about 15° C. to about 25° C., a separating electrical potential in a range of about 7 V to about 9 V, and a separating electrical current in a range of about 1.5 amps to about 3.5 amps for a separating duration in a range of about 1.5 hours to about 2.5 hours.
24. The method of Embodiment 1, wherein:
   the product lanthanide is ¹⁷⁷Lu;
   the non-product lanthanide is ¹⁷⁶Yb;
   the mercury cathode, prior to conditioning the electrochemical cell, is about 99.999% mercury;
   the anode is platinum, wherein the anode has a surface area in a range of about 25 cm² to about 35 cm²;
   the initial electrolyte solution has lithium citrate as alkali metal salt in a lithium ion concentration in a range of 0.40 M to about 0.60 M, and the initial solvent is water;
   said conditioning comprises operating the electrochemical cell under an inert atmosphere while agitating the cathode at a conditioning temperature in a range of about 15° C. to about 25° C., a conditioning pH that is at about 6.5, a conditioning electrical potential of about 8 V, and a conditioning electrical current of about 2 amps for a conditioning duration of about 1 hour;
   the second solvent is trifluoromethane sulfonic acid at a concentration in a range of about 3 M to about 3.5 M; and
   the step (c) comprises operating the electrochemical cell under an inert atmosphere while agitating the cathode at a separating temperature in a range of about 15° C. to about 25° C., a separating pH that is about 6.5, for a separating duration of about 2 hours, and at a separating electrical potential of about 8 V and a separating electrical current of about 2.5 amps.
25. The method of any of Embodiments 15 to 24, wherein the conditioning pH during the conditioning step (a), or the separating pH during the separation step (c), or the conditioning pH and the separating pH are controlled via addition of a base.
26. The method according to Embodiment 25, wherein the base is an alkali metal hydroxide.
27. The method according to Embodiment 26, wherein the base is selected from the group consisting of lithium hydroxide, sodium hydroxide, potassium hydroxide, preferably lithium hydroxide.
28. The method according to any of Embodiments 25 to 27, wherein the controlling of the separating pH is periodic or continuous.
29. The method according to any of Embodiments 25 to 28, wherein the controlling of the separating pH is by incremental additions of a lithium hydroxide solution.
30. The method of Embodiment 29, wherein the lithium hydroxide solution has a concentration of about 3 M.
31. The method of any of Embodiment 15 to 30, wherein the inert atmosphere is an argon purge at about atmospheric pressure.
32. The method of any of Embodiments 15 to 31, wherein the argon purge is run for at least 30 minutes immediately preceding conditioning the cathode.
33. The method of any of Embodiments 2 to 32, wherein, immediately after the conditioning step, the cathode comprises reduced alkali metal, preferably lithium, at a concentration relative to the mercury that is in a range of about 50 ppm to about 1,000 ppm.
34. The method of any of Embodiments 2 to 32, wherein, immediately after the conditioning step, the cathode comprises reduced alkali metal, preferably lithium, at a concentration relative to the mercury that is in a range of about 100 ppm to about 800 ppm.
35. The method of any of Embodiments 2 to 32, wherein, immediately after the conditioning step, the cathode comprises reduced alkali metal, preferably lithium, at a concentration relative to the mercury that is in a range of about 150 ppm to about 500 ppm.
36. The method of any of Embodiment 1 to 35, wherein said mixture comprising the product lanthanide and non-product lanthanide is from an irradiated target that comprises said mixture as oxides, preferably wherein the irradiated target has a mass in a range of about 0.5 g to about 10 g and a radioactivity in a range of about 555 Gbq to about 15000 Gbq.
37. The method of Embodiment 36, further comprising dissolving said mixture comprising the product lanthanide and non-product lanthanide in the second solvent within a dissolution container, wherein the step of adding the other solution to the initial electrolyte solution comprises adding the contents of the dissolution container to the initial electrolyte solution.
38. The method of Embodiment 37, further comprising rinsing the dissolution container with a volume of a rinse solution, wherein the rinse solution comprises a dissolved lithium salt selected from the group consisting of lithium tartrate, lithium acetate, lithium citrate, and combinations; and
   wherein the step of adding the other solution to the initial electrolyte solution further comprises adding said volume of the rinse solution used to rinse the dissolution container to the initial electrolyte solution.
39. The method of Embodiment 38, wherein the rinse solution is an aqueous 1.0-1.5 M lithium citrate solution.
40. The method of any of Embodiments 1 to 39, wherein the other solution has a mass ratio of non-product lanthanides to product lanthanides that is in a range of about 1000:1 to about 4000:1.
41. The method of any of Embodiments 1 to 40, wherein the separating step (c) is a single, continuous operation of the electrochemical cell until at least 90% of the non-product lanthanide in the separation electrolyte solution is reduced and amalgamated with the mercury cathode.
42. The method of any of Embodiments 1 to 40, wherein the separating step (c) is a single, continuous operation of the electrochemical cell until at least 99% of the non-product lanthanide in the separation electrolyte solution is reduced and amalgamated with the mercury cathode.
43. The method of Embodiment 42, wherein the product solution comprising the dissolved product lanthanide comprises no more than 20 ppm of mercury.
44. The method of any of Embodiments 1 to 43, wherein the method comprises a step of ion exchange of the product solution comprising the dissolved product lanthanide using an anionic exchange resin, thereby reducing dissolved mercury in the product solution and recovering an ion exchange product solution.
45. The method of Embodiment 44, wherein the step of ion exchange comprises use of an aqueous hydrochloric acid.
46. The method of Embodiment 44 or 45, wherein the step of ion exchange comprises:
   i. adding a volume of a hydrochloric acid solution to the product solution to form an acidified solution;
   ii. passing the acidified solution through an ion exchange column comprising an anion exchange resin pre-equilibrated with 0.15 M HCl so that mercury ions adsorb to the anion exchange resin to form a reduced-mercury solution that comprises dissolved product lanthanide, non-product lanthanide, and alkali metal ions; and
   iii. passing a 0.15 M HCl rinse through the ion exchange column after the passing of the acidified solution to collect remaining amounts of the product lanthanide, non-product lanthanide, and alkali metal ions within the ion exchange column;
wherein the reduced-mercury solution, said passed rinse, or the combination thereof is an ion exchange product solution.
47. The method of Embodiment 46, wherein:
   the hydrochloric acid solution is an aqueous concentrated HCL solution (˜11.5 M);
   the anion exchange resin is a styrene-divinylbenzene-based resin; and
   the rinse is an aqueous 0.15 M HCl solution.
48. The method of Embodiment 46 or 47, wherein the ion exchange product solution has a concentration of mercury that is no greater than 10 ppb.
49. The method of any of Embodiments 1 to 48, further comprising performing chromatographic separation of the ion exchange product solution to separate product lanthanide, non-product lanthanide, and alkali metal ions.
50. The method of Embodiment 49 comprising:
   i. loading the ion exchange product solution to a chromatography column comprising a chromatography resin capable of adsorbing product lanthanide and non-product lanthanide without adsorbing alkali metal ions thereby adsorbing product lanthanide and non-product lanthanide;
   ii. washing the loaded chromatography column with a chromatography wash solution to remove alkali metal ions from the chromatography column without desorbing product lanthanide and non-product lanthanide from the chromatography resin; and
   iii. passing a chromatography eluent solution through the washed chromatography column having adsorbed product lanthanide and non-product lanthanide, wherein the product lanthanide and non-product lanthanide desorb from the chromatography resin and separate as they travel through the column in the chromatography eluent solution at different rates according to their respective distribution coefficients for the column thereby separating the product lanthanide and the non-product lanthanide into product lanthanide-containing eluate and non-product lanthanide-containing eluate, respectively.
51. The method of Embodiment 50, wherein the chromatography resin comprises an alkyl derivative of phosphoric acid on inert supports.
52. The method of Embodiment 51, wherein the alkyl derivative of phosphoric acid is selected from the group consisting of di(2-ethylhexyl)orthophosphoric acid (HDEHP), 2-ethylhexylphosphonic acid mono-2-ethylhexyl ester (HEH[EHP]), and di-(2,4,4-trimethylpentyl)phosphinic acid (H[TMPeP]).
53. The method of Embodiment 50, wherein the chromatography resin comprises an alkylphosphoric acid alkyl ester on inert supports.
54. The method of Embodiment 50, wherein the chromatography resin comprises (2-ethylhexyl)phosphonic acid-(2-ethylhexyl)-ester (HEH[EHP]) on inert supports.
55. The method of any of Embodiments 50 to 54, wherein:
   the chromatography wash solution is an aqueous 0.15 M HCl solution;
   the chromatography eluent solution is an aqueous 1.4 to 1.5 M HCl solution; and
   the chromatography column is at a temperature in a range of about 40° C. to about 55° C. during the chromatographic separation process.
56. The method of any of Embodiments 49 to 55, wherein the step of ion exchange is carried out before or after the step of chromatographic separation.
57. The method of any of Embodiments 49 to 55, wherein the step of ion exchange is carried out before the step of chromatographic separation.
58. The method of Embodiment 57, wherein the chromatographic separation process further separates mercury within the ion exchange product solution thereby resulting in the product lanthanide-containing eluate having a concentration of mercury that is no greater than 1 ppb.
59. The method of Embodiment 57 or 58 further comprising a step of reformulating the product lanthanide-containing eluate by heating the product lanthanide-containing eluate under an inert atmosphere to form a solid residue comprising product lanthanide.
60. The method of Embodiment 59, wherein the product lanthanide of the solid residue is product lanthanide chloride hydrate.
61. The method of Embodiment 59, wherein the product lanthanide of the solid residue is ¹⁷⁷LuCl₃·nH₂O.
62. The method of Embodiment 61, wherein the ¹⁷⁷LuCl₃·nH₂O has a specific activity in a range of about 2775 GBq to about 4070 GBq per mg of Lu-177.
63. The method of any one of Embodiments 1 to 62 further comprising recovering non-product lanthanide by the following steps:
   contacting the mercury cathode and the electrochemical cell with an acid solution to extract non-product lanthanide therein to form a non-product lanthanide-containing solution;
   precipitating non-product lanthanide from the purified non-product lanthanide-containing solution with oxalic acid to form a non-product lanthanide oxalate salt; and
   heating the non-product lanthanide oxalate salt to form recovered non-product lanthanide oxide.
64. The method of Embodiment 63, wherein the non-product lanthanide oxalate salts are ¹⁷⁶Yb₂(Oₓ)₃ and the recovered non-product lanthanide oxide is ¹⁷⁶Yb₂O₃.
65. A method of producing a solution of a product lanthanide, preferably a non-carrier-added (n.c.a) product lanthanide solution, more preferably n.c.a. ¹⁷⁷Lu, said method comprising:
   providing a mixture comprising a product lanthanide and non-product lanthanide;
   separating the product lanthanide and non-product lanthanide according to any of Embodiments 49 to 64;
   wherein after the step of chromatographic separation eluates comprising the product lanthanide are concentrated in inert atmosphere; and
   a solution comprising a product lanthanide, preferably non-carrier added (n.c.a) product lanthanide solution, more preferably n.c.a ¹⁷⁷Lu is recovered.
66. The method of Embodiment 65, wherein the recovered solution comprising the product lanthanide, preferably non-carrier added (n.c.a) product lanthanide comprises more than 98% non-carrier added (n.c.a) product lanthanide, preferably more than 99% n.c.a. 177Lu.
67. The method of Embodiment 65 or 66, wherein the recovered solution comprising a product lanthanide, preferably non-carrier added (n.c.a) product lanthanide comprises more than 98% non-carrier added (n.c.a) product lanthanide, preferably more than 99% n.c.a. ¹⁷⁷Lu with a specific activity of >2900 GBq/mg.
68. The method of any of Embodiments 65 to 67, wherein the method comprises providing about 0.5 to 10 g and about 555 GBq to 15000 Gbq of a mixture of product and non-product lanthanides.
69. The method of any of Embodiments 66 to 68, wherein said mixture of product radiolanthanides and non-product lanthanides was generated by applying neutron irradiation to a target of ¹⁷⁶Yb, preferably ytterbium oxide, to generate the radioisotope ¹⁷⁷Yb, and allowing the target to decay to produce ¹⁷⁷Lu from ¹⁷⁷Yb after beta-decay.

1.-137. (canceled)

138. A method of separating a product lanthanide and a non-product lanthanide that are in a mixture, the method comprising:
separating the product lanthanide and the non-product lanthanide by electrolyzing the mixture while controlling the pH of the mixture to be in a range of about 6.0 to about 7.0 by addition of a base during electrolysis of the mixture;
wherein:
the base is an alkali metal hydroxide;
the controlling of the pH is periodic or continuous; and
the electrolyzing the mixture comprises:
dissolving the product lanthanide and the non-product lanthanide that are in the mixture with a trifluoro-methane sulfonic acid solution;
a mercury cathode;
and an anode.

139. The method of claim 138, wherein:
the product lanthanide is lutetium;
the non-product lanthanide is ytterbium;
the base is selected from the group consisting of lithium hydroxide, sodium hydroxide, and potassium hydroxide;
the trifluoro-methane sulfonic acid solution has a concentration of 2 M to 4 M;
the pH is controlled to be about 6.5;
the mercury cathode has a surface area of 40 to 120 cm² and the electrolyzing the mixture further comprises stirring the mercury cathode at a rate of 200 to 400 rpm; and
the anode comprises a metal is selected from the group consisting of ruthenium, palladium, osmium, iridium, platinum, and alloys or combinations thereof.

140. The method of claim 138, wherein:
the product lanthanide is ¹⁷⁷Lu;
the non-product lanthanide is ¹⁷⁶Yb;
the base is lithium hydroxide;
the trifluoro-methane sulfonic acid solution has a concentration of 3 M to 3.5 M;
the pH is controlled to be about 6.5;
the mercury cathode has a surface area of 75 to 85 cm² and the electrolyzing the mixture further comprises stirring the mercury cathode at a rate of 280 to 300 rpm; and
the anode is platinum.

141. The method of claim 138 further comprising:
a step of pre-electrolysis of an initial electrolyte solution comprising lithium citrate, wherein at least a portion of the lithium ions of the lithium citrate of the initial electrolyte solution are reduced;
a step of ion exchange carried out using an anionic exchange resin after the electrolyzing of the mixture; and
a step of chromatographic separation carried out before or after the step of ion exchange, wherein the step of chromatographic separation comprises only one chromatographic column or two chromatographic columns connected in parallel.

142. A method of separating a product lanthanide and a non-product lanthanide that are in a mixture by electrolysis, the method comprising:
a step of pre-electrolysis, wherein an initial electrolyte solution comprising an alkali metal salt and free of the product lanthanide and the non-product-lanthanide is conditioned by electrolysis so that at least a portion of the alkali metal ions of the alkali metal salt of the initial electrolyte solution are reduced and amalgamated in a mercury cathode, and wherein the alkali metal salt is lithium citrate and the alkali metal ions are lithium ions.

143. The method of claim 142, wherein:
the product lanthanide is lutetium;
the non-product lanthanide is ytterbium;
the initial electrolyte solution has an alkali metal ion concentration in a range of about 0.15 M to about 0.90 M; and
the mercury cathode has a surface area of 40 to 120 cm².

144. The method of claim 142, wherein:
the product lanthanide is ¹⁷⁷Lu
the non-product lanthanide is ¹⁷⁶Yb;
the mixture has a radioactivity of at least 185 GBq;
the initial electrolyte solution has an alkali metal ion concentration in a range of about 0.40 M to about 0.60 M; and
the mercury cathode has a surface area of 75 to 85 cm².

145. The method of claim 142, wherein the product lanthanide and the non-product lanthanide that are in the mixture originate from an irradiated target that comprises said mixture as oxides, wherein the irradiated target has a mass in a range of about 0.5 g to about 10 g and a radioactivity in a range of about 555 Gbq to about 15000 Gbq.

146. The method of claim 142, wherein the electrolysis of the mixture further comprises:
dissolving the product lanthanide and the non-product lanthanide that are in the mixture by trifluoro-methane sulfonic acid;
controlling the pH of the mixture to be in a range of about 6.0 to about 7.0 by addition of a base during the electrolysis of the mixture; and
stirring the mercury cathode at a rate of 200 to 400 rpm.

147. The method of claim 142 further comprising:
a step of ion exchange using an anionic exchange resin, after the electrolysis of the mixture; and
a step of chromatographic separation before of after the step of ion exchange.

148. A method of separating a product lanthanide and a non-product lanthanide that are in a mixture, the method comprising:
a. providing an electrochemical cell, wherein the electrochemical cell comprises:
i. a mercury cathode;
ii. an anode; and
iii. an initial electrolyte solution comprising alkali metal ions from an alkali metal salt dissolved in an initial solvent comprising water, wherein the initial electrolyte solution is in contact with the mercury cathode and the anode;
b. adding a second solution to the initial electrolyte solution in the electrochemical cell to form a separation electrolyte solution that is in contact with the mercury cathode and the anode, wherein the second solution comprises:
i. a mixture comprising the product lanthanide and the non-product lanthanide; and
ii. a second solvent capable of dissolving said mixture comprising the product lanthanide and the non-product lanthanide without reacting with the anode and the mercury cathode; and
c. separating the non-product lanthanide from the separation electrolyte solution, wherein said separating comprises operating the electrochemical cell to:
i. reduce the oxidation state of at least a portion of the non-product lanthanide;
ii. amalgamate the reduced non-product lanthanide with the mercury of the mercury cathode; and
iii. recovering a product solution that comprises dissolved product lanthanide;
thereby separating product lanthanide and non-product lanthanide.

149. The method of claim 148, wherein:
the cathode surface area is refreshed while operating the electrochemical cell to separate the non-product lanthanide from the separation electrolyte solution, wherein the surface area of the cathode is refreshed by flowing the mercury of the mercury cathode so that the mercury at or near the interface with the separation electrolyte solution is transported away from the interface before formation of a layer of reaction product(s) extending from the interface into the volume of the mercury cathode, wherein said layer would inhibit the reduction of the oxidation state of the non-product lanthanide and/or the amalgamation of the reduced non-product lanthanide; and
the electrochemical cell comprises a flow device for flowing the mercury of the mercury cathode, and wherein the flow device is configured and operated to flow the mercury to refresh the surface area of the cathode without disturbing amalgamated solids at the bottom of the mercury cathode.

150. The method of claim 148, wherein:
the product lanthanide is lutetium;
the non-product lanthanide is ytterbium;
the mercury of the provided mercury cathode at least about 99% pure;
the cathode has a surface area of in a range of about 40 cm² to about 120 cm²;
the anode comprises a metal selected from the group consisting of ruthenium, rhodium, palladium, osmium, iridium, platinum, and alloys, mixtures, or combinations thereof;
the anode has a surface area in a range of about 10 cm² to about 40 cm²;
the initial electrolyte solution has an alkali metal ion concentration in a range of about 0.15 M to about 0.90 M;
the alkali metal ion is lithium ions;
the alkali metal salt is lithium citrate;
the second solvent is trifluoromethane sulfonic acid solution having a concentration in a range of about 2 M to about 4 M; and
the step (c) comprises operating the electrochemical cell under inert atmosphere while flowing the cathode at a separating pH that is in a range of 6.0 to 7.0 at a separating temperature in a range of about 10° C. to about 30° C., a separating electrical potential in a range of about 5 V to about 10 V, and a separating electrical current in a range of about 1 amps to about 4 amps for a separating duration in a range of about 0.5 hours to about 4 hours;
the separating step (c) is a single, continuous operation of the electrochemical cell until at least 90% of the non-product lanthanide in the separation electrolyte solution is reduced and amalgamated with the mercury of the mercury cathode; and
the product solution comprising the dissolved product lanthanide comprises no more than 20 ppm of mercury.

151. The method of claim 148, wherein:
the product lanthanide is ¹⁷⁷Lu;
the non-product lanthanide is ¹⁷⁶Yb;
the mercury of the provided mercury cathode is about 99.999% pure;
the cathode has a surface area of in a range of about 75 cm² to about 85 cm²;
the anode comprises platinum;
the anode has a surface area in a range of about 25 cm² to about 35 cm²;
the initial electrolyte solution has an alkali metal ion concentration in a range of about 0.40 M to about 0.60 M;
the alkali metal ion is lithium ions;
the alkali metal salt is lithium citrate;
the second solvent is trifluoromethane sulfonic acid solution having a concentration in a range of about 3 M to about 3.5 M;
the step (c) comprises operating the electrochemical cell under inert atmosphere while flowing the cathode at a separating pH of about 6.5, a separating temperature in a range of about 15° C. to about 25° C., a separating electrical potential of about 8 V, and a separating electrical current of about 2.5 amps for a separating duration in a range of about 1.5 hours to about 2.5 hours;
the separating step (c) is a single, continuous operation of the electrochemical cell until at least 99% of the non-product lanthanide in the separation electrolyte solution is reduced and amalgamated with the mercury of the mercury cathode; and
the product solution comprising the dissolved product lanthanide comprises no more than 20 ppm of mercury.

152. The method of claim 148 further comprising conditioning the provided electrochemical cell before adding the second solution to the initial electrolyte solution to:
reduce the oxidation state of at least a portion of the alkali metal ions in the initial electrolyte solution; and
amalgamate the reduced alkali metal with mercury of the mercury cathode so that the mercury cathode additionally comprises an alkali metal amalgam;
wherein the conditioning of the provided electrochemical cell comprises operating the electrochemical cell under an inert atmosphere, while flowing the cathode, at a conditioning pH that is in a range of about 6.0 to about 7.0, a conditioning temperature in a range of about 10° C. to about 30° C., a conditioning electrical potential in a range of about 5 V to about 10 V, and at a conditioning electrical current in a range of about 1 amps to about 4 amps for a conditioning duration in a range of about 0.5 hours to about 2 hours.

153. The method of claim 152, wherein:
the conditioning pH during the conditioning, the separating pH during the separation step (c), the conditioning pH, and the separating pH are controlled via periodic or continuous addition of a lithium hydroxide solution;
the inert atmosphere is an argon purge at about atmospheric pressure for at least 30 minutes immediately preceding conditioning the cathode; and
immediately after the conditioning step, the cathode comprises reduced alkali metal at a concentration relative to the mercury that is in a range of about 50 ppm to about 1,000 ppm.

154. The method of claim 148, wherein said mixture comprising the product lanthanide and non-product lanthanide is from an irradiated target that comprises said mixture as oxides, and the irradiated target has a mass in a range of about 0.5 g to about 10 g and a radioactivity in a range of about 555 Gbq to about 9250 Gbq; and
the method further comprises dissolving the irradiated target that comprises said mixture comprising the product lanthanide and non-product lanthanide as oxides in the second solvent within a dissolution container; and
wherein the step of adding the second solution to the initial electrolyte solution comprises adding the contents of the dissolution container to the initial electrolyte solution; and
wherein the second solution has a mass ratio of non-product lanthanides to product lanthanides that is in a range of about 1,000:1 to about 4,000:1.

155. The method of claim 154 further comprising rinsing the dissolution container with a volume of a rinse solution, wherein the rinse solution is an aqueous lithium citrate solution; and
wherein the step of adding the second solution to the initial electrolyte solution further comprises adding said volume of the rinse solution used to rinse the dissolution container to the initial electrolyte solution.

156. The method of claim 148 further comprising a step of ion exchange of the product solution that comprises:
contacting the dissolved product lanthanide with an anion exchange resin thereby reducing dissolved mercury in the product solution; and
recovering an ion exchange product solution.

157. The method of claim 156, wherein the step of ion exchange comprises:
adding a volume of a hydrochloric acid solution to the product solution to form an acidified solution;
passing the acidified solution through an ion exchange column comprising the anion exchange resin so that mercury ions adsorb to the anion exchange resin to form a reduced-mercury solution that comprises dissolved product lanthanide, non-product lanthanide, and alkali metal ions; and
passing a rinse through the ion exchange column after the passing of the acidified solution to collect remaining amounts of the product lanthanide, non-product lanthanide, and alkali metal ions within the ion exchange column;
wherein said reduced-mercury solution, said passed rinse, or the combination thereof is the ion exchange product solution, wherein the ion exchange product solution has a concentration of mercury that is no greater than 10 ppb.

158. The method of claim 157, wherein:
the hydrochloric acid solution is an aqueous 11.5 M HCl;
the anion exchange resin is a styrene-divinylbenzene-based resin; and
the rinse is an aqueous 0.15 M HCl solution.

159. The method of claim 156 further comprising performing chromatographic separation of the ion exchange product solution to separate product lanthanide, non-product lanthanide, and alkali metal ions.

160. The method of claim 159, wherein the chromatographic separation comprises:
loading the ion exchange product solution to a chromatography column comprising a chromatography resin capable of adsorbing product lanthanide and non-product lanthanide without adsorbing alkali metal ions thereby adsorbing product lanthanide and non-product lanthanide;
washing the loaded chromatography column with a chromatography wash solution to remove alkali metal ions from the chromatography column without desorbing product lanthanide and non-product lanthanide from the chromatography resin; and
passing a chromatography eluent solution through the washed chromatography column having adsorbed product lanthanide and non-product lanthanide, wherein the product lanthanide and non-product lanthanide desorb from the chromatography resin and separate as they travel through the column in the chromatography eluent solution at different rates according to their respective distribution coefficients for the column thereby separating the product lanthanide and the non-product lanthanide into product lanthanide-containing eluate and non-product lanthanide-containing eluate, respectively.

161. The method of claim 160, wherein:
the chromatography resin comprises an alkyl derivative of phosphoric acid on inert supports, wherein the alkyl derivative of phosphoric acid is selected from the group consisting of di(2-ethylhexyl)orthophosphoric acid (HDEHP), 2-ethylhexylphosphonic acid mono-2-ethylhexyl ester (HEH[EHP]), and di-(2,4,4-trimethylpentyl)phosphinic acid (H[TMPeP]);
the chromatography wash solution is an aqueous 0.15 M HCl solution;
the chromatography eluent solution is an aqueous 1.4 to 1.5 M HCl solution; and
the chromatography column is at a temperature in a range of about 40° C. to about 55° C. during the chromatographic separation process.

162. The method of claim 159, wherein:
the step of ion exchange is carried out before the step of chromatographic separation; and
the chromatographic separation process further separates mercury within the ion exchange product solution thereby resulting in the product lanthanide-containing eluate having a concentration of mercury that is no greater than 1 ppb.

163. The method of claim 162 further comprising a step of reformulating the product lanthanide-containing eluate by heating the product lanthanide-containing eluate under an inert atmosphere to form a solid residue comprising product lanthanide, wherein the product lanthanide of the solid residue is ¹⁷⁷LuCl₃·nH₂O having a specific activity in a range of about 2900 GBq/mg Lu to about 4070 GBq/mg Lu.

164. The method of claim 148 further comprising recovering non-product lanthanide by the following steps:
contacting the mercury cathode and the electrochemical cell with an acid solution to extract non-product lanthanide therein to form a non-product lanthanide-containing solution;
precipitating non-product lanthanide from the purified non-product lanthanide-containing solution with oxalic acid to form a non-product lanthanide oxalate salt; and
heating the non-product lanthanide oxalate salt to form recovered non-product lanthanide oxide.

165. The method of claim 164, wherein the non-product lanthanide oxalate salt is 16Yb₂(Oₓ)₃ and the recovered non-product lanthanide oxide is ¹⁷⁶Yb₂O₃.

166. A method of producing a solution of a non-carrier-added (n.c.a) product lanthanide, the method comprising:
providing a mixture comprising the product lanthanide and a non-product lanthanide;
separating the product lanthanide and the non-product lanthanide according to the method of claim 160; and
wherein, after the step of chromatographic separation, the product lanthanide-containing eluate is concentrated in inert atmosphere and the non-carrier added (n.c.a) product lanthanide solution is recovered.

167. The method of claim 166, wherein:
the mixture comprising the product lanthanide and a non-product lanthanide was generated by applying neutron irradiation to a target of ytterbium-176 oxide to generate the radioisotope ¹⁷⁷Yb, and allowing the target to decay to produce ¹⁷⁷Lu from ¹⁷⁷Yb after beta-decay, and the mixture is about 0.5 to 10 g and about 555 GBq to 15000 Gbq; and
the non-carrier added (n.c.a) product lanthanide is more than 99% n.c.a. ¹⁷⁷Lu with a specific activity of ≥2900 GBq/mg Lu.
